(19) United States
(12) Patent Application Publication
(10) Pub. No.: US 2012/0042002 A1
(43) Pub. Date: Feb. 16, 2012

(54) SYSTEM AND METHOD FOR CONTEXT DRIVEN CENTRALIZED HELP

(76) Inventors: Tony Paul Smith, Coggeshall (GB); Julian Hartley Cork, Little Chalfont (GB); Tuan Long Pham, Bishops Stortford (GB); Milind Kulkarni, Katy, TX (US); Sergejs Olhoviks, Rego Park, NY (US); Vince Sethi, Eastleigh (GB); Anthony Brian Knife, Romford (GB); Tarik Cherkaoui, New York, NY (US); Richard Alexander Hill, Glasgow (GB)

(21) Appl. No.: 12/477,821

(22) Filed: Jun. 3, 2009

(51) Int. Cl. G06F 15/16; G06F 17/30

(52) U.S. Cl. 709/203; 707/769; 707/E17.014

(57) ABSTRACT

A system and method for context driven centralized help is provided. A daemon application initiated on a workstation or mobile device is configured to intercept a help request received in connection with an active application when a pre-defined triggering event is invoked. The daemon application captures context corresponding to the current page or function in use with the active application and generates a corresponding information dataset pertaining to the captured context. The information dataset is transmitted to a remote site, configured to query a content database, to determine if help-related content has been previously associated with the captured context, wherein a positive determination of the existence of such an association results in the help-related content being retrieved and displayed on the workstation or mobile device.

### BACKGROUND OF THE INVENTION

1. Field of the Invention

The present invention relates generally to product support services. More specifically, the present invention is directed at a system and method for providing a context driven help solution infrastructure.

2. Description of Related Art

Product support services are intended to provide end-users with access to resources for retrieving information pertaining to the use and know-how of a computer application. Typically, in providing these services, help files and tutorials are packaged with the software for the computer application, whether as printed materials or computer-readable data files. Organizations, which may employ a plurality of computer applications, are also known to supplement these services by retaining application specialists and other qualified professionals to provide added support and assistance.

However, despite the availability of the forgoing, these product support services are quickly losing viability. Much of today's computer applications are more advanced and seem to provide an endless number of functions and capabilities, leaving end-users stranded with the time consuming and tedious task of searching through large amounts of help-related data that may or may not assist them, thereby ultimately yielding an inefficient application support structure. Similarly, organizations retaining computer application professionals on-site as a means of addressing the need for adequate support are being burdened with the ever-increasing costs associated with maintaining this support structure. In view of these ongoing advancements and corresponding difficulties, end-users today require a more robust means for retrieving product support services.

It is therefore an object of the present invention to provide a product support structure that is decoupled from the limitations associated with a computer application. It is a further object of the present invention to provide a centralized product support structure that can be configured for use across a plurality of local, as well as web accessible, client-based applications, while at the same time maintaining transparency from an end-user's perspective. It is yet another object of the present invention to provide an improved searching means for retrieving and delivering product support information.

### SUMMARY OF THE INVENTION

The foregoing objects are accomplished in accordance with the principles of the present invention by providing a context driven help solution infrastructure.

The infrastructure envisioned by the present invention is preferably implemented via a client/server-based communication network, wherein a computer application (hereinafter “the active application”) is made accessible to an end-user on a client-oriented computer workstation or, alternatively, an application-enabled mobile device. In addition to providing access to an active application, the workstation or mobile device may be further configured with a daemon application or service (hereinafter “the daemon application”) to monitor select actions taken by an end-user. In a preferred embodiment, the daemon application may remain dormant on the workstation or mobile device, while also maintaining transparency from the end-user's perspective, until a pre-defined triggering event is detected, the triggering event corresponding to the end-user invoking a request for help.

Context-specific help-related content may be retrieved from a remote site, having at least one server coupled to a content database, when the end-user's request for help is invoked on the workstation or mobile device running the active application. Upon detecting the pre-defined triggering event associated with the request for help, the daemon application may be awakened to intercept the end-user's request. Once intercepted, the daemon application may employ a help function to capture qualifying context existing on a page or pertaining to a function in connection with the active application. Thereafter, an information dataset, representative of the context captured from the active application, may be generated and transmitted to the remote site for querying the content database. If the captured context is matched with previously associated help-related content, the content may be retrieved from the database and displayed to the end-user on the workstation or mobile device executing the active application.

### BRIEF DESCRIPTION OF THE DRAWINGS

The above and other objects and advantages of the present invention will become apparent upon consideration of the following detailed description, taken in conjunction with the accompanying drawings, in which like reference characters refer to like parts throughout, and in which:

FIG. 1 illustrates a block diagram of an exemplary communication system for implementing a context driven help solution in accordance with preferred embodiments of the present invention.

FIG. 2 is a process flow diagram illustrating the steps employed for associating an active application with a help page in accordance with an embodiment of the present invention.

FIG. 3 is a process flow diagram illustrating the steps employed for retrieving a help page in accordance with an embodiment of the present invention;

### DETAILED DESCRIPTION OF THE PREFERRED EMBODIMENTS

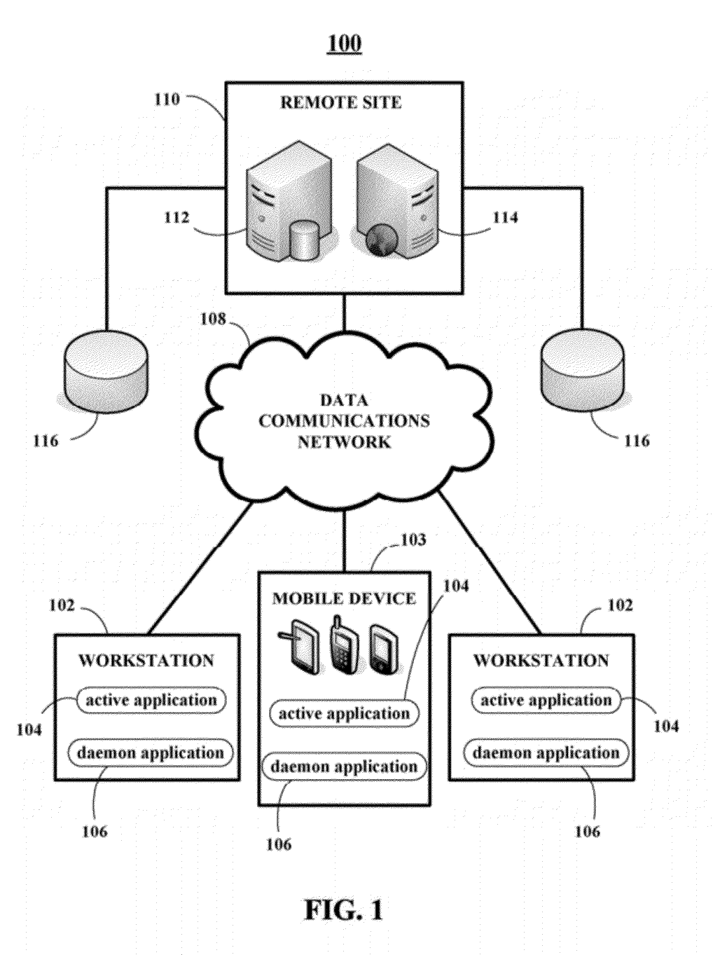

FIG. 1 shows an exemplary communication system 100 in accordance with the present invention. For purposes of clarity, and not by way of limitation, an illustrative client-server based embodiment of the present invention is herein described. System 100 may include computer workstations 102, mobile device 103 and a remote site 110, which may all be linked via a data communications network 108. In practice there may be additional computer workstations 102, mobile devices 103 and remote sites 110, but to avoid over-complicating the drawing only a limited number of these networked components are shown.

Computer workstations 102 and mobile device 103 may be operated by an authorized end-user and configured to run at least one active application 104 and a daemon application 106. Computer workstations 102 and mobile device 103 may include, but are by no means limited to, a desktop computer, a laptop computer, a mainframe computer, a personal digital assistant (PDA) or any other suitable application-enabled data processing device. Any device configured to process, manage or transmit data, whether implemented with electrical components, magnetic components, optical components or otherwise, may be suitable for implementing the present invention.

Remote site 110 may include one or more servers such as, for example, a database server 112 and a web server 114. Alternatively, servers 112 and 114 may not be segregated at all, but rather all necessary applications and functions may reside on a single server. Servers 112 and 114 may be coupled to one or more content databases 116, for storing and retrieving data. For example, pre-defined web pages for responding to context driven help queries may be kept and accessed from the foregoing databases. Alternatively, one or more mirrored servers may be provided as a backup for holding current databases and updated web applications. In other suitable approaches, such as in non-Internet based approaches, remote site 110 may include an application server (not shown) or any other suitable server or combination of servers.

The term “server”, as used herein, is not limited to a distinct piece of computing hardware or storage component, but may also be a software application or a combination of hardware and software. For example, a computer may have software that enables the computer to act as both a web server and as a database server. Remote site 110, therefore, may be any suitable remote site and may include any combination of equipment comprised of one or more servers, mainframes, personal computers or any other suitable computer-based equipment. Remote site 110 may also include a network of computers that may be interconnected, for example, through a local area network, a wide area network, a telephony network, a cable television network, an intranet network, the Internet or any other suitable wired or wireless communications network.

Computer workstations 102 and mobile devices 103 may communicate with remote site 110 via network 108 using any suitable communication means. Communications may include, for example, commands, requests, messages, remote procedure calls, a combination thereof or any other suitable client-server or peer-to-peer communication mechanism. For example, computer workstation 102, mobile device 103 and remote site 104 may communicate over network 108 using any suitable protocol or protocol stack such as the one used in transmission control protocol/Internet protocol (TCP/IP) environments. Communications may also involve, for example, complex communications between application constructs running on workstations 102 or mobile device 103 and remote site 110.

Data communications network 108 may be any suitable communications network, such as a local area network, a wide area network, a telephone network, a cable television network, an intranet network, the Internet or any other suitable wired or wireless communications network. Some suitable wireless communications networks may be, for example, a global system for mobile communications (GSM), time-division multiple access (TDMA), code-division multiple access (CDMA), Bluetooth or any other suitable wireless technology.

It should be noted that the foregoing system is not limited to the components described herein. Various other networking components, devices and systems may be incorporated into communication system 100 for achieving the objectives of the present invention, the specifics of which are described in more detail in conjunction with the drawing figures that follow.

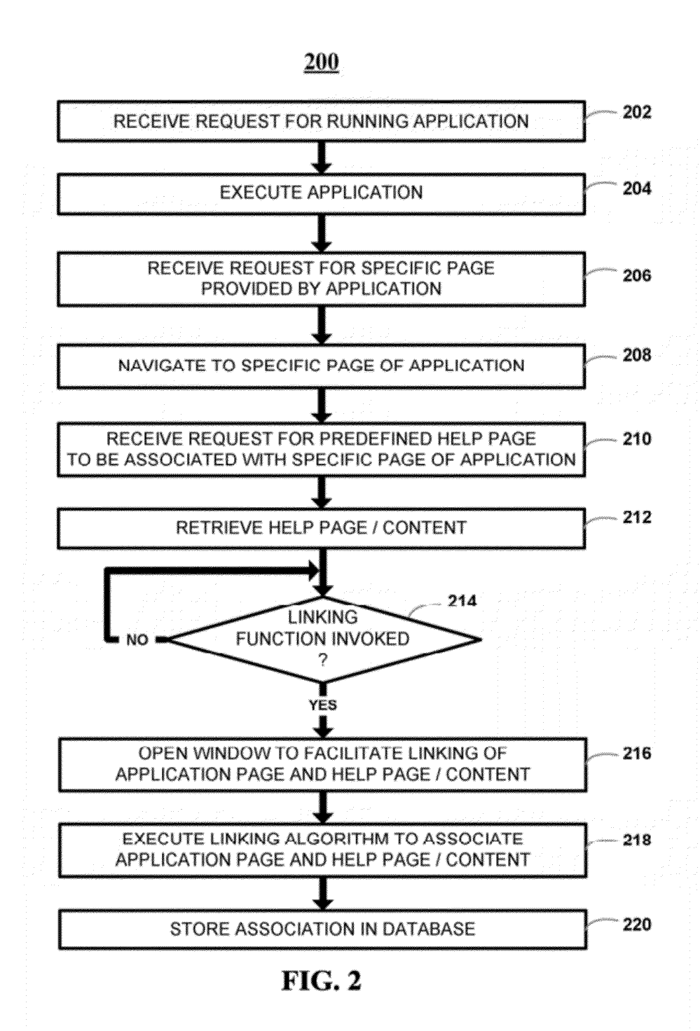

In FIG. 2, a process flow 200 is provided to illustrate the steps that may be employed in associating a particular page or function of active application 104 with help-related content stored, for example, in content database 116. The term “active application” is intended to include, but is not limited to, both local and web-based applications accessible via computer workstation 102 and mobile device 103.

Process flow 200 begins, at step 202, when a request to start active application 104 is received, said active application 104 being accessible to an end-user on a display (not shown) coupled to workstation 102 or device 103 upon running the application's corresponding executable code at step 204. In another suitable embodiment, process flow 200 may also be deployed, for example, on a personal computer located at remote site 110. When active application 104 is made accessible for use, a request for a particular page or program associated with active application 104 may then be received, at step 206, for navigating, at step 208, to the desired page or program of interest. Upon navigating to the desired page, an end-user of workstation 102 or mobile device 103, or similarly an administrator at remote site 110, may make a request, at step 210, for a predefined help page or any other form of help-related content stored, for example, in content database 116 in order to associate the help content with the desired page of interest in active application 104.

When the requested help-related content is retrieved, at step 212, the content may be linked with the desired page navigated to, at step 208, in active application 104. The retrieved help-related content may be provided, for example, in a web page format residing on web server 114. The web page may be displayed to an end-user in a web browser on workstation 102 or mobile device 103. Upon retrieving and displaying the web page from web server 114 on workstation 102 or mobile device 103, a linking function may then be invoked to associate the retrieved help-related content with the desired page of active application 104.

A determination is made, at step 214, as to whether or not the linking has been invoked. The linking function may be invoked, for example, by configuring a combination of hot keys on an input device (e.g., the CNTRL and F1 keys on a QWERTY keyboard) coupled to workstation 102 for summoning the function. Upon detecting, at step 214, that a linking function has been invoked, a linking software application window may be opened and displayed to the end-user, at step 216, for providing a plurality of configuration options with respect to how the desired page of active application 104 and the retrieved help content, both being displayed on workstation 102, are to be linked together. Qualifying context-based criteria may be automatically detected by the linking software application to identify fields in the desired page of active application 104 where context can be extracted for linking the desired page of active application 104 with the retrieved help content.

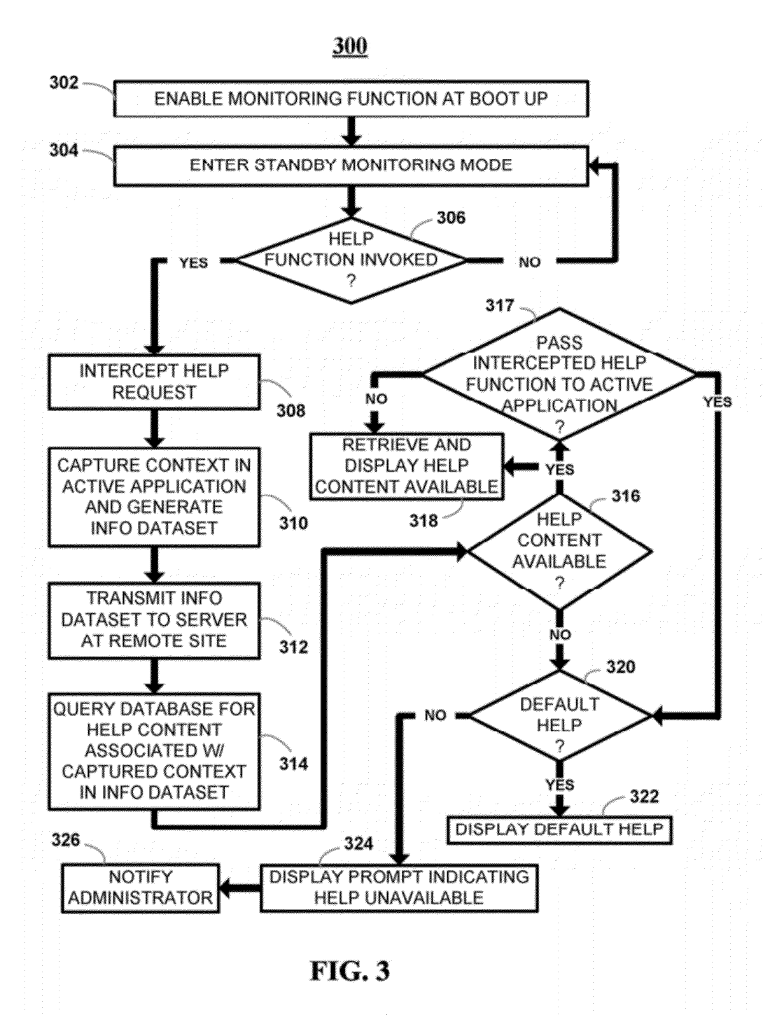

For example, the foregoing linking function is ideal for a web-based active application 104. Web-based applications typically have a heading or identifier (e.g., the title appearing at the top of the page in a browser window) and a corresponding unique web page address (i.e., the URL string). As previously suggested, the linking software application, when invoked at step 214, may be configured to automatically identify these aforementioned fields as qualifying context-based criteria, wherein the qualifying context may be extracted for linking the desired page of the web-based application with a corresponding help page retrieved from a remote server. This now allows an end-user invoking a help request on the same web-based application to be directed to the help page that was previously linked to the web-based application. Thus, an end-user on workstation 102 or mobile device 103, invoking a help function (described in conjunction with FIG. 3) may now be directed to a context-specific help page having particular relevance to the page or function being accessed by the end-user on active application 104, rather than a generic help page that may be packaged with active application 104.

Once a desired configuration has been selected, an algorithm for linking a page or function in active application 104 with a pre-defined help-related page retrieved from remote site 110 is executed, at step 218, in accordance with the desired configuration, thereby resulting in a association between the desired page of active application 104 and the help-related page being created. The association and the defining context-based criteria used to create the association may be stored, at step 220, in content database 116 coupled to remote site 110 for future retrieval.

In FIG. 3, a process flow 300 is provided to illustrate the steps employed in requesting help-related content previously associated with a desired page or function of active application 104. To deploy the steps illustrated in process flow 300, workstation 102 or mobile device 103 may be equipped with daemon application 106. In a preferred embodiment, daemon application 106 is configured to run in the background, transparent to an end-user on workstation 102 or mobile device 103, awaiting a triggering event to be invoked.

Daemon application 106 may be further configured so that the monitoring function of the application is initiated during the boot cycle of workstation 102 or mobile device 103, thereby making it completely transparent to the end-user on workstation 102 or mobile device 103. Daemon application 106 may also be configured so that the help retrieval function of process 300 is invoked upon the use of a hot key (e.g., the F1 key on a QWERTY keyboard) on an input device coupled to workstation 102 or mobile device 103, thereby providing a means for intercepting a request or action regularly associated with the hot key and, alternatively, returning a response in accordance with the retrieval function of daemon application 106. As previously described, the term “hot key” is intended to include, but is not limited to, a specific key or combination of keys, for example, on a QUERTY keyboard. In alternative embodiments, other suitable input means may be utilized in conjunction with workstation 102 or mobile device 130 to invoke execution of the retrieval function of daemon application 106. The method for designating hot keys may be hard-coded within an application or made accessible for end-user configuration.

Turning now to FIG. 3, process flow 300 begins by enabling, at step 302, the monitoring function of daemon application 106, which is preferably initiated, at step 304, in a standby mode after booting up workstation 102 or mobile device 103. Once initialized, daemon application 106 may remain dormant until a trigging event occurs. A triggering event, as previously described, could be the keystroke of a designated hot key. Thus, in an embodiment of the present invention where the “F1” key on a QWERTY keyboard is designated as the hot key, a triggering event will occur when an end-user strikes the F1 key.

To continue the transition through process flow 300, an end-user running active application 104 on workstation 102 or mobile device 103 may choose to request help for a particular page or function in current use on active application 104. To call for a help request, the end-user may strike a designated key that is known to retrieve a help tutorial associated with active application 104. However, through pre-configuration of daemon application 106 that designated key may be defined as a hot key for indicating a triggering event. Thus, when the end-user requesting help strikes the corresponding designated key, a triggering event will be deemed to have occurred and a set of instructions may be deployed by daemon application 106 for over-riding the default response associated with the designated key. Instead, a context-specific help function may be deployed, at step 306, for retrieving a help page previously associated (as described in conjunction with process flow 200 of FIG. 2) with the aforementioned page or function in current use by the end-user on active application 104.

Invoking the help function, at step 306, permits daemon application 106 to intercept the end-user's ordinary request for help, at step 308, and capture qualifying context, at step 310, detected in the page or function in current use on active application 104. Qualifying context captured, at step 310, may then be coded accordingly by daemon application 104 for transmission to remote site 110 by generating, for example, an information dataset corresponding to the specific page or function running on active application 104 at the moment the end-user's help request was invoked.

The term “information dataset” is intended to include, but is not limited to, data pertaining to context captured from a page or function on active application 104 that would be useful in querying and retrieving help content that may have been previously associated with the captured context. For example, the information dataset generated by daemon application 106 may contain metadata pertaining to the captured context, from which remote site 110 may use to identify and retrieve a help page previously associated with a corresponding help file stored in content database 112.

The information dataset generated subsequent to interception of the end-user's help request by daemon application 106 may include, but is not limited to, the name of active application 104 running on workstation 102 or mobile device 103, a corresponding version number of active application 104, the language active application 104 is being displayed in, a combination thereof and any other pertinent indicia for identifying active application 104. For example, a user may be utilizing a particular function (e.g., tables) in the word processing application of Microsoft Word 2003, English version 1.1 on workstation 102. In this example, the word processing application of Microsoft Word 2003 would be considered active application 104. The triggering event for summoning the help function of daemon application 106 may be preconfigured to be associated with the activation of an F1 key, which may be known to activate the ordinary help feature packaged with select versions of Microsoft Word. Therefore, employing the principles of the present invention, the context captured and the corresponding information dataset generated, at step 310, by daemon application 106 upon selection of the F1 key may include information identifying that the table function in Microsoft Word 2003, English version 1.1 was being used when the end-user's help request was intercepted at step 308.

After the context is captured and a corresponding information dataset is generated, at step 310, daemon application 106 may be configured to transmit, at step 312, the information dataset to database server 112 at remote site 110. Database server 112 may then query, at step 314, content database 116 to determine if help content has been previously associated with the captured context represented in the information dataset generated and transmitted by daemon application 106. If a corresponding association is determined to exist, at step 316, a URL linking to the help content may be retrieved and displayed, at step 318, on workstation 102 or mobile device 103. Alternatively, prior to displaying help content retrievable from content database 116, an additional check may be deployed at step 317 to determine if an end-user has instead elected to pass the keystroke triggering the help function request invoked at step 306 directly to the active application that it was initially intercepted from at step 308. If a positive determination is made at step 317, then process 300 may revert to help content packaged with active application 104, the availability of which is determined at step 320.

The present invention is not limited to the foregoing means for displaying help-related content. The nature of active application 104 may dictate the way information received from remote site 110 is displayed on workstation 102 or mobile device 103. For example in an embodiment of the present invention where active application 104 is a web-based application executed in a web browser on workstation 102, the help-related content received may be displayed in separate browser window or, alternatively, in a window pane within the boundaries of the main browser window in which active application 104 is running. Given that the end-user of active application 104 in the foregoing example is already operating within a web browser, displaying the received help-related content in a web browser may prove easier for the end-user. There may, however, be embodiments of the present invention where the identity of active application 104 may dictate the means by which information received from remote site 110 is displayed on workstation 102 or mobile device 103. For example, in determining the appropriate means for displaying help-related content retrieved from remote site 110, factors including data type or format of the content being received, functionality of the active application 104 and capacity of workstation 102 or mobile device 103 may be considered.

If the determination, at step 316, reveals that there is no pre-defined association between the captured context represented in the information dataset and the help-related content stored in content database 116, daemon application may then be further configured to terminate the query made at step 314, and permit active application 104 to regain control and check, at step 320, for help-related content packaged with active application 104. If such content exists, active application 104 may display, at step 322, the default help-related content. Alternatively, if the check, at step 320, determines that no default help-related content is available with active application 104, a message or any other suitable notification may be generated, at step 324, by daemon application 106 to inform the end-user on workstation 102 or mobile device 103 that the request for help can not be satisfied at the present time and an administrator has been notified, at step 326, of the unfulfilled request.

When the administrator, or any other authorized end-user, receives the foregoing notification generated at step 326 from daemon application 106, a help file or page may be constructed and associated with the page or function in active application 104 determined to be deficient in support. This association may be achieved in accordance with the previously described steps employed by process flow 200 of FIG. 2. Content database 116 may be configured to allow for various product support information to be updated or altered without manipulation of active application 104. As opposed to existing methods for providing updated content to each instance of active application 104, a content provider need now only update the information stored in content database 116 in order to provide the most current content available. The process of updating content stored in content database 116 is transparent to the active application 104.

In an alternative embodiment, a drag and drop window application (not shown) may be provided to an end-user on workstation 102 or mobile device 103 to trigger the previously described help function of daemon application 106. The drag and drop window application may be configured to receive a URL that is dragged from a web browser's address field for a web page being presently displayed, for example, on workstation 102 and dropped into a designated field of the drag and drop window application. The act of dropping a URL into the designated field of the window application may invoke the previously described help function, at step 306, wherein context-specific help content previously associated with the URL may then be retrieved by daemon application 106 in accordance with the previously described steps employed in process flow 300 of FIG. 3.

Thus, a system and method for context driven centralized help is provided. One skilled in the art will appreciate that the present invention can be practiced by other than the described embodiments, which are presented herein for purposes of illustration and not of limitation, and the present invention is limited only be the claims that follow.

1. A computer-implemented method for retrieving context sensitive help-related content, said method comprising the steps of:
initiating a daemon application, wherein said daemon application is configured to run in the background of a client device and is transparent to an end-user of said client device, and wherein said daemon application remains dormant until a triggering event associated with a help request is invoked on said client device;
intercepting said help request upon detection of said triggering event;
capturing context associated with a page or function of an active application running on said client device, wherein said help request was initiated during use of said active application;
generating an information dataset corresponding to said captured context;
transmitting said information dataset to a remote site, wherein a server is configured to query a content database for said help-related content previously associated with said captured context; and
displaying said help-related content retrieved by said server on said client device.

2. The method of claim 1, wherein said daemon application is a software application installed locally on said client device.

3. The method of claim 1, wherein said daemon application is a web-based service accessible through said client device.

4. The method of claim 1, wherein said triggering event is detected when at least one pre-designated hot key is selected.

5. The method of claim 1, wherein said captured context may be associated with a plurality of pages having said help-related content.

6. The method of claim 1, wherein said information dataset is comprised of data identifying said active application's name, said active application's version, said active application's language, said page or function being displayed or used in said active application at the time said help request is received, a uniform resource locator (URL) of a web-based active application, a title provided in a web browser of said web-based active application or a combination thereof.

7. The method of claim 1, wherein said help-related content is displayed on said client device via a URL fetch from said server at said remote site.

8. A non-transitory computer readable medium having stored thereon a plurality of instructions, the plurality of instructions including instructions that, when executed by a processor, cause the processor to perform the steps of a method for retrieving context sensitive help-related content, said method comprising the steps of:
initiating a daemon application, wherein said daemon application is configured to run in the background of a client device and is transparent to an end-user of said client device, and wherein said daemon application remains dormant until a triggering event associated with a help request is invoked on said client device;
intercepting said help request upon detection of said triggering event;
capturing context associated with a page or function of an active application running on said client device, wherein said help request was initiated during use of said active application;
generating an information dataset corresponding to said captured context;
transmitting said information dataset to a remote site, wherein a server is configured to query a content database for said help-related content previously associated with said captured context; and
displaying said help-related content retrieved by said server on said client device.
